(19) United States
(12) Patent Application Publication
(10) Pub. No.: US 2002/0185359 A1
(43) Pub. Date: Dec. 12, 2002

(54) Robot having interlock mechanism

(76) Inventors: John Scott Livingston, Garland, TX (US); Stan Wilson, Mansfield, TX (US); Karl Stutsman, Southlake, TX (US)

Correspondence Address: ROBERT C. ROLNIK, NOKIA INC., 6000 CONNECTION DRIVE, MD 1-4-755, IRVING, TX, 75039, US

(21) Appl. No.: 09/875,654

(22) Filed: Jun. 6, 2001

(51) Int. Cl. B65G 29/00

(52) U.S. Cl. 198/468.2

(57) ABSTRACT

A robot workstation having a work-support frame (111) is shown which may be installed or replaced in or around an assembly line organized along a pallet conveyor system (151). The robot workstation may have one or more interlocks (119). An arm (101) may move through a range of motion along a track (103) supported by a back support (105) and a front support (107). The arm (101) may have an end effector (109). The workstation may be elevated from the floor by one or more legs (115).

### BACKGROUND

The invention relates to automated processes along an assembly line, and more particularly to robotic placement, machining and processing of parts.

In the field of automated assembly, there has been a continuing drive to achieve a number of goals including using less floor space, using fewer people, enhancing flexibility and maintenance, and minimizing quantity of expensive machines while maintaining a level of safety, production and quality.

In the assembly of handheld and other small electrical devices, a series of fabrication techniques are used to produce a final product suitable for sale at a consumer retail level. Among the process steps that unite raw parts to form a final product are: surface mount component placement, soldering, pick and placing of electro-mechanical parts, testing, and packaging.

The picking and placing of electro-mechanical parts very often involves placement of such parts on a work surface, which may be a printed circuit board, in the case of assembly of electrical items. One or more circuit boards may be moved from one assembly station to another by riding on a pallet. The pallet may be moved by a pallet conveyor system, which typically takes a linear path from a beginning or upstream workstation, to a ending or downstream workstation. A human operator or factory worker may man some of these workstations. Other workstations may be automated wherein placement of a part is performed by a robot.

Robots have operated along an assembly line for a number of industries. An assembly line is a conveying system that moves an unfinished workpiece or chassis through a number of workstations where parts are added and processes occur. The chassis accumulates parts and refinements as it passes along the assembly line. The line is generally a straight line, however, it is known that a chassis may be elevated or otherwise move off a direct linear path. Workpieces or chassis have been carried by a number of motivating means, such as belts, chains and pallet conveyors among others. Such a conveying means is not necessarily continuous and gaps on the order of an inch between conveying means are allowable without changing the character of the two conveyors being parts of a single assembly line.

A pallet conveying system is a modular unit that is easily managed to construct an assembly line. Generally a pallet conveying system is available from a manufacturer in a limited number of sizes. Several pallet-conveying systems are placed end to end to provide an assembly line of the desired length. An assembly line may be supported by the floor, or by frames that elevate the assembly line to a height that is comfortable for a human being to service.

Since robots eventually break down, there is a possibility that an assembly line that relies on such a robot will come to a halt, unless there is a redundant backup for that robot. For that reason, it is important that there are at least two robots available on the assembly line to keep production occurring. Moreover, it is helpful if there is a quick way to service the failed robot of a pair of redundant robots.

Robots are generally complex machines. A typical laser printer is a robot that operates along a single track. For that reason it is a single degree of freedom robot. A degree of freedom is a movement enabled by a motive means to extend or swivel a movable robot part about another part of the robot. A degree of freedom may include rotational movement, sliding movement or translation, or extending movement, by e.g. a piston. To accomplish elaborate placement of parts, it is frequently necessary to use robots that have two or three degrees of freedom. For each degree of freedom, there is usually needed a motor and some way to track position for purposes of providing feedback. Thus for a three degree of freedom, there is often three motor inputs and at least three positioner outputs. Such data has been controlled by a robot controller, which almost always relies on a central processing unit or embedded processor. At the actuation of one or more motors, a robot may move an end effector through a range of operation. The mass of the end effector, and any part it picks up, is frequently accelerated. This may result in vibration, particularly if the robot is moving at high speed. An end effector may include devices that grasp multiple components at the same time. Several motors, pumps or other mechanical or fluidic devices may control an end effector. The term end effector may include devices that grasp one or more components contemporaneously with placing or releasing one or more components. The term end effector may also include a machine tool such as a screwdriver bit, or drill that performs a machining or fastening step. An end effector may perform the machining operation on several chassis simultaneously. Similarly an end effector may perform the machining operation on several places of a single chassis simultaneously.

The processor and associated circuits has, in the past, been an assembly of modular components having, in some cases hand-assembled connections between mother boards and daughter boards. Since such a processor and its associated circuits can be susceptible to failure if subjected to vibration, those devices have been provided an independent means of support. Modern processors have been built that are more than adequate to handle the chores of robot control, while relying more completely on permanent solder joints. Moreover, such processors are often available in forms compatible with network protocols and are thus able to integrate with a network. Consequently there has been less need to shelter such processors that form a robot controller from a high-vibration environment.

Operators of factory equipment must observe certain safety precautions. Risks may be higher where robots are in use. One precaution established is that no operator may be present in the cell of a robot while that robot is operational. A cell is the full extent of travel of the moving parts of the robot. A cell may include the extent of travel of any end effector connected to the robot. The fact that a robot may be programmed to halt at a point does not diminish the extent of a cell. A robot may be programmed to move through only a small volume of a cell, i.e. an effective workspace, but the safety precaution applies to the broader cell. This is because, frequently, software may have bugs, or unexpected interactions with networked equipment. Hence there is this expanded zone of safety. Nevertheless, because machines are not as precious as human life, it is permissible to have two robots operate such that the cells for each robot overlap each other.

Although robots may have coextensive cells, it is often prohibited to do repairs on a robot that may share portions of a cell of a second operating robot. Thus, though two robots may achieve redundancy by being placed in such a manner, a repair will often require that both machines be taken out of service, thus losing, even for a brief period, the redundant effect.

Surface mount component assembly machines are very large pieces of machinery. One is often needed for each independent assembly line, and typically two lines do not share the same surface mount component assembly machine. Such an arrangement prevents a faulty surface mount component assembly machine from stopping production on the two assembly lines.

An operator of an assembly line is assigned the task of placing raw parts in positions that may be reached by each robot. The parts are often packaged in a manner that presents the part in a reliable location and orientation to the machine. Sometimes the parts are packaged in a spool configuration. Sometimes the parts are packaged in a tray configuration. A feeder apparatus moves a spool or tray into a position for an end effector to grasp parts that are carried in such packaging. For an operator to be most effective, it is helpful that the feeders are spaced relatively close together so that inspection and loading may be done with a minimum of walking between the feeders.

### SUMMARY

An embodiment may be a dual robot station for use in or around an assembly line. Two robots may support each other. A first robot may have a robot arm attached to a first end effector. The first robot may comprise a first frame, wherein the robot has a range of operation between a left side of the frame and a right side of the frame such that parts of the frame are a width apart. A pallet conveyor may deliver pallets to a first exit near the left side of the frame. The pallet conveyor may receive pallets from an entrance near the right side of the frame. A second robot may have a robot arm attached to a second end effector. The second robot may comprise a second frame, wherein the robot has a range of operation between a left side of the frame and a right side of the frame such that parts of the frame are a width apart. A second pallet conveyor may deliver pallets to a second exit near the left frame of the second robot. The pallet conveyor may receive pallets from an entrance near the right side of the frame of the second robot. The second end effector may be substantially the same as the first end effector.

A multi-axis robot station embodiment may be supported by a floor. The multi-axis robot station may comprise a support base having a depth and a width. Such a multi-axis robot station may be relatively stable though it has a center of gravity high above the floor in relation to a supporting base width.

Chief among the benefits of one or more embodiments may be that a robot workstation that comprises a part of an embodiment may be built using a compact support structure that may be more amenable to positioning among other robot workstations for purposes of building a line of assembling robot workstations and otherwise maintaining such a line. Rapid deployment and repair of such a line of assembling robots may be achievable.

### BRIEF DESCRIPTION OF THE DRAWINGS

The disclosed embodiments of the invention will be described with reference to the accompanying drawings, wherein:

FIG. 1a is an oblique view of a robot workstation according to an embodiment of the invention;

FIG. 1b is a block diagram of a controller and associated communication hardware;

FIG. 2a shows a top view of several embodiments fastened together;

FIG. 2b is an elevation view of a robot station according to an embodiment of the invention; and

FIG. 2c shows a top view of a robot station according to an embodiment of the invention.

### DETAILED DESCRIPTION

A robot comprises a controller, at least one motive means, e.g. a motor, and at least one arm. An end effector is not necessary to be added to the device to make it a robot. A controller may be very rudimentary and need not necessarily operate electronically. A motive means may be a compressed fluid source, e.g. for pneumatic actuation. A motive means may be a device operable based on an electric on magnetic field, e.g. a motor.

In situations where two or more robot workstations are redundant to each other and each robot workstation performs a process, e.g. assembly, with a part, parts that are within a first robot workstation cell are said to be local parts with respect to the first robot workstation. Any part that is not within the first robot workstation cell is said to be a remote part with respect to that first robot workstation.

Presence of a part, with respect to the ability of a sensor to measure aspects of a part, may be a characteristic of a part that is measured along a continuum. Such measurements may occur along multiple dimensions, e.g. location and orientation. Other dimensions of presence are possible, however, it is understood that presence detection may include one or more measurements by one or more sensors at one or more times. At its simplest level, presence may be measured as to poles: present or absent. At more complex levels of abstraction, presence may be measured as a degree to which a part is located where it is expected to be. With respect to a volume, e.g. a cell, a part may be present both within the volume and outside the volume.

A fault may be determined where a part is present to such a little extent that it is highly likely that a robot workstation may not be able to perform normal processes such as assembly on the part. There may be a small likelihood that a robot may be able to process the part, however, a judgment, which may be based on previous data, is made to set criteria for determining faults to be conservative. A human operator, who programs a robot workstation, accordingly may make such a judgment.

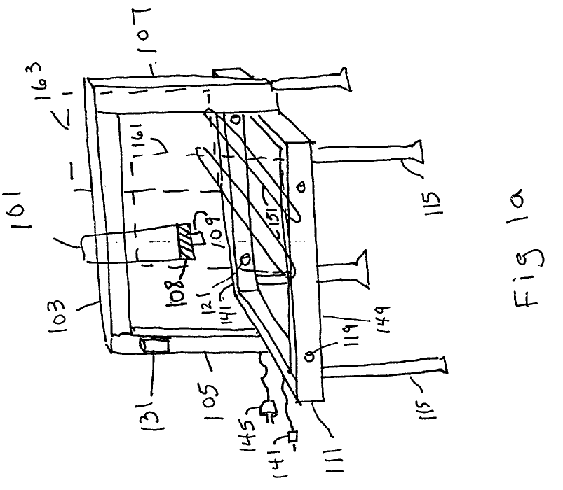

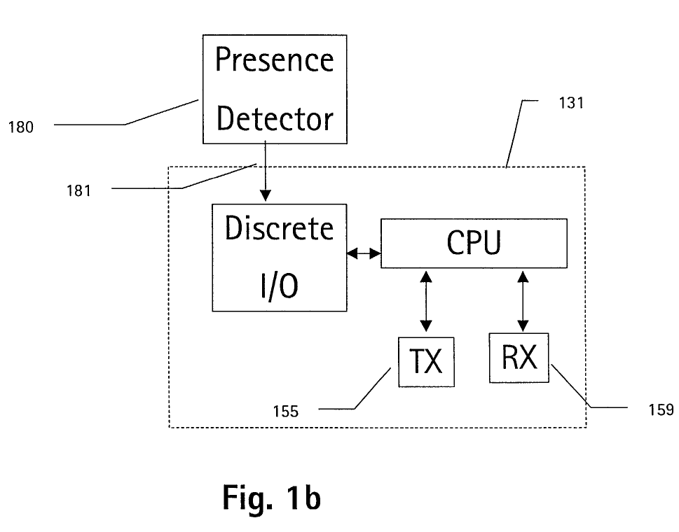

FIG. 1a shows an oblique view of a robot portion of an embodiment of the invention. The robot may be a Cartesian robot, and may comprise a linear axis arm 101 mounted on a track 103 supported by a back support 105 and a front support 107. The linear axis arm 101 may provide one axis of motion for the robot, which may be a multi-axis robot. Additional sliding arms may be attached to the linear axis arm 101 as is known in the art. One of the slide arms may have an end effector 109 attached to it. One or more motors may drive the movements of the end effector 109. It may be advantageous to use an induction motor. Other robots may be used, such as those operating according to swiveling movements such as, e.g. SCARA robots.

End effector 109 may be one of several types of end effectors that may be placed on a robot arm. End effector may be attached by using bolts, screws or other fastening means. Alternatively, a mating system 108 may be used, wherein such a mating system may be rigidly engage to the end effector 109 by operation of a motive force in a positive manner, e.g. compressed air, as is known in the art. Similarly, application of a motive force, possibly in an opposing manner, may cause the release of the end effector from the mating system 108 such that the end effector is no longer rigidly engaged to the mating system 108. The mating system 108 may have bulkheads and conduits for providing fluids such as compressed air to an end-effector 109, thereby providing greater flexibility to control the end effector 109 and any processes the end effector is used for. The mating system 108 may have electrical conductors having sockets or pins to mate with reciprocal sockets or pins in the end effector 109. Such electrical conductors may provide power to motors or pumps that operate on or near the end effector 109, among other material handling and processing devices known in the art. Such conductors are known as electric outputs of the mating system. Similarly, the electrical conductors may operate as conduits to a controller 131 to provide sensor readings, e.g. as from a tactile feedback sensor on or in the end effector 109. These conductors are known as electrical inputs of the mating systems. The electrical inputs to the end-effector 109 may originate from the controller 131, while electrical outputs from the end effector 109 may be carried to the controller 131. Compressed air may be available from a nearby compressor and air network controlled by solenoids or valves as is known in the art. Both compressed air and electrical signals may be carried to and from the mating system 108 by support in, on or near each member or part of a robot arm to sources of compressed air or electricity. Moreover, a vacuum may be substituted for compressed air, and may be selectable by the controller 131. More than one mating system may be connected to a robot arm.

The presence of electrical conductors at a mating system 108 may be intended to provide a greater flexibility in selecting and powering an end-effector. One or more such electrical conductors may be unconnected to a reciprocal conductor or connector of a rigidly engaged end effector. Similarly, the presence of conduits for fluid at the mating system 108 may also be intended to provide a greater flexibility in controlling processes in or near the end effector 109. An end effector rigidly engaged to the mating system 108 may make no use of such fluids.

The robot may include a work-support frame 111, which may be bolted or otherwise fastened to a support including the back support 105. Work-support frame 111 may rest on a factory floor if it is unnecessary for human operators to do any service to the robot. If it anticipated that human operators may need to service the robot, it may be helpful to support the work-support frame 111 on elevating means or a table. Table may be constructed by means known in the art. Alternatively, elevating means may be one or more legs 115 affixed to the robot. Such legs may be adjustable to provide a greater height or permit all feet to be in contact with the floor. The legs alone, or alternatively the table, may comprise a support base, having a base width. One or more wheels may be attached to the work-support frame 111 to aid in movement of the robot workstation in and out of an assembly line. The wheels may support the robot workstation if legs 115 are adjusted short enough.

An innovation of the embodiment is the use of a left interlock 119 and a right interlock 121. A left frame 149 may support the left interlock 119. A right frame 141 may support the right interlock 121. The interlock of a single robot may mate to and securely hold or otherwise fasten a interlock of a second robot. By attaching a robot to a neighbor robot in this way, the collective mass of the frames may be increased and by so doing improve the resistance of the frame structure to vibration and any propensity to rock. In other words, there may be a diminished unbalanced-washer effect. This may permit a selection of legs or table to be used that function more directly as a vertical support and less directly as a means to dampen vibrations. In short, the weight of any table or other elevating means may be reduced so that such a structure may be cheaper to construct and easier to move.

The work-support frame may provide support for a pallet conveyor 151. The pallet conveyor 151 may be a part of a larger assembly line. The pallet conveyor may rest gently on the work-support frame 111, or it may be locked into place with screws or other fastening means.

The pallet conveyor system 151 may support pallets of many different sizes. The pallet conveyor 151 may move such pallets in a generally horizontal direction. Tangential to the horizontal direction is two planes through which the pallets may pass. Situated in these planes are two areas known as the pallet entrance 161 and the pallet exit 163. The pallet entrance 161 extends above a left frame and the pallet exit 163 extends above a right frame 141. In all cases, the pallet entrance is limited to an area below any track 103 or the highest point at which the end effector 109 may operate. The pallet entrance 161 may be located in substantial vertical alignment with the left frame 149, while the pallet exit may be located in substantial vertical alignment with the right frame 141.

The pallet conveyor 151 may extend substantially from the pallet entrance 161 to the pallet exit 163. It is permissible to leave a gap of up to a centimeter or two between an end of the pallet conveyor 151 and the pallet entrance. Similarly it is permissible to leave a gap of up to a centimeter or two between a second end of the pallet conveyor 151 and the pallet exit 163. This narrow range of tolerance must be sufficiently small to allow a pallet conveyor situated in an adjacent robot workstation of similar construction to load or unload a pallet from its pallet conveyor into or from the present robot workstation.

The robot may have a localized controller 131, which may provide current to one or more motors to assure proper acceleration and positioning of the end effector 109. Controller 131 may have a programmable network address, which may be a unique address, and provide data collected by one or more sensors at the workstation through a data cable 141, which may interconnect to a data network by means known in the art. The one or more sensors may include a presence detector 180. The presence detector may provide a presence output 181, which indirectly or directly reaches the controller 131. The network address may be unique among all robots that concurrently operate on an assembly line. Such an address may permit the controller 131 to collect data concerning the location and calibration of a robot end effector. The controller 131 may collect the status of each feeder connected to the workstation, which may include the availability of parts at a feeder and whether the feeder is empty. Controller 131 may provide motor inputs to control a trajectory path of an end effector. Controller 131 may provide local storage and provide a means to receive software downloads from a computer on the network, wherein the software downloads provide information concerning part size, location in feeders, intended placement of a part among other part and process steps. Such software downloads may influence the type of task or process that the robot workstation is responsible for, and may control the identity of the robot workstation as being redundant to another robot workstation. A separate power cable 145 may be provided to power one or more robot motors and controller 131. If a pallet conveyor system is on the robot frame, such a pallet conveyor system may draw current from a common power cable 145.

FIG. 1b shows a block diagram of the controller 131. Controller 131 may have a discrete input/output module 151 having at least one port for receiving signals that indicate the nature of the presence or absence of a component part that may be ready for assembly. Controller 131 may determine whether a fault exists with respect to parts arriving from a feeder 190. Such a fault condition may be dependent on the location of the part on, in or near the feeder nearest to a presence detector 180. Such a fault condition may be dependent on the orientation of the part on, in or near the feeder nearest to a presence detector 180. Such a fault condition may be dependent on the completeness of the part on, in or near the feeder nearest to a presence detector 180. The controller 131 may be connected to a transmitter 155, which may be a portion of a transceiver as is known in the art. Transmitter 155 may deliver a status signal in the form of data packets or other digital signals to a network device, including a second controller operating as part of a second robot workstation. Such status signals may include a unique address of the originating robot workstation or controller. Such status signals may include information based on the presence of a component part, i.e. a status signal may be a fault signal.

Similarly, controller 131 may have a receiver 159, which may be a portion of a transceiver. Receiver 159 may receive a status signal from a second workstation, or from an intermediate network device. If such a status signal indicates a fault, and the fault originates from a robot workstation that is redundant to the local robot workstation, then the controller 131 may command the robot workstation to perform a process on any chassis that are not processed, or may not be processed by, the second robot workstation. Conversely, if the controller 131 receives a status signal that indicates a remedy to a fault (e.g. based on the presence of a component part at the second robot workstation), then the controller 131 may command the robot workstation to perform a process on fewer than all chassis that pass through the robot workstation.

Transmitter 155 and receiver 159 may operate according to a high-speed data networking protocol such as IEEE 1394. Transmitter 155 and receiver 159 may operate according to a high-speed wireless data protocol, such as, e.g. Bluetooth.

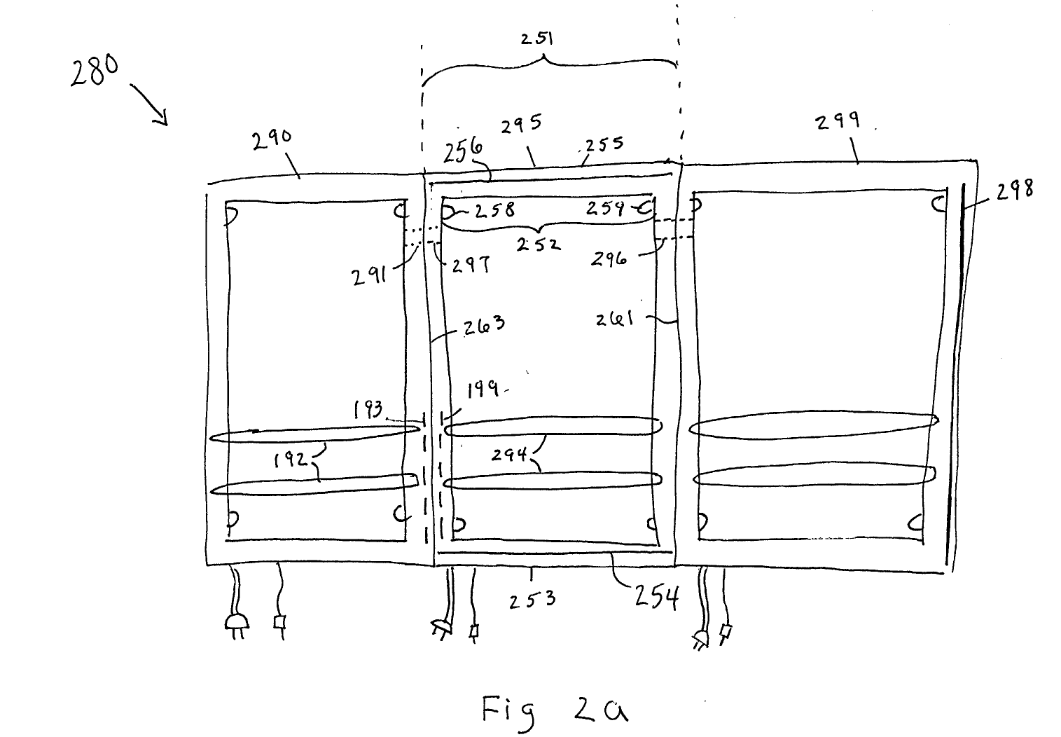

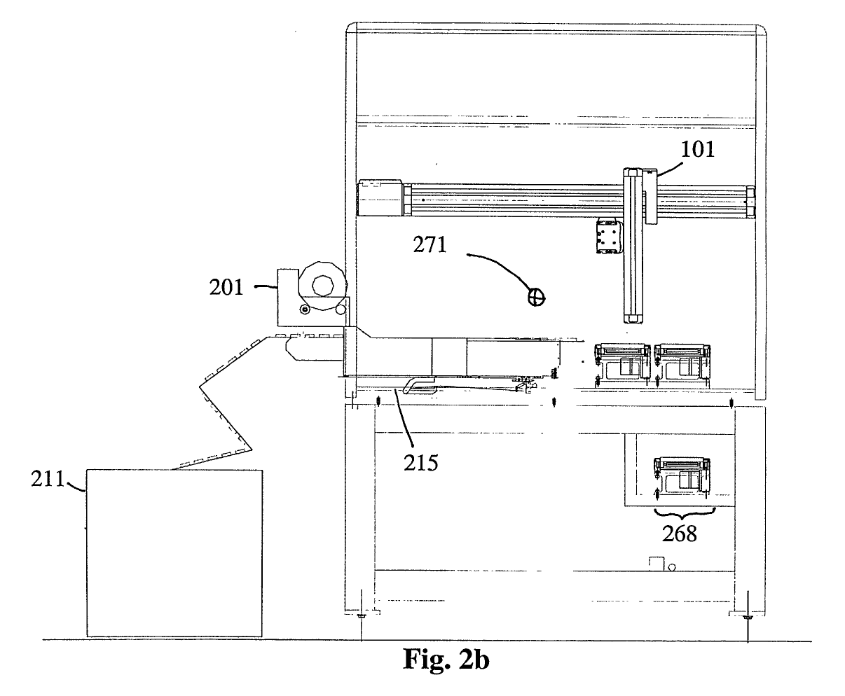

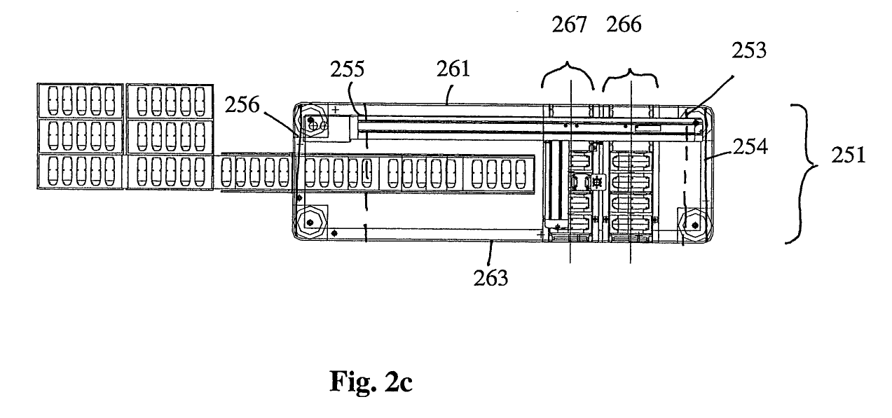

FIG. 2a shows a top view of several embodiments fastened together. For the sake of clarity, the robot arm, track and end effectors are not shown, however, it is appreciated that each robot workstation may be equipped with such components. Installation of an embodiment may occur as follows. Two robot workstation embodiments may be placed side to side so that a first interlock 291 of a first robot 290 is aligned with a second interlock 297 of a second robot 295. If the interlock comprises a latch, the latch may be engaged to form a rigid attachment between a first work support frame and a second work-support frame, i.e. so that the first work support frame is rigidly engaged to the second work support frame. Similarly, any other interlock may be engaged to form a rigid attachment between a first work support frame and a second work-support frame. The power cables of the respective robots may be attached to a power supply. The data cables of the respective robots may be attached to a common data network cable or to a factory data network. In an embodiment that supports a pallet conveyor, the pallet conveyor 192 of the first or upstream robot workstation 290 presents a first pallet exit 193 near the downstream robot workstation's second pallet entrance 199 thus providing a path where the first pallet conveyor 192 may unload a pallet to the pallet conveyor 294 of the downstream or second robot workstation 295.

Each of the robots may use an identical end effector or end effector array. If a pallet conveyor system 192 is located on a work-support frame of the first robot 290 and a second pallet conveyor system 294 located on a work-support frame of the second robot 295, then if such second pallet conveyor system 294 is out of alignment, adjustments may be made. A robot arm may be moved through a work envelope above the left frame 261 and the right frame 263. So long as the robot arm operates between a vertical plane extending through the left frame 261 and a vertical plane extending through the right frame 263, the robot arm is said to have a range of motion between the right frame 263 and the left frame 261.

A third robot workstation embodiment 299 may be placed at an open side of the second robot workstation 295. The third interlock of the third robot 299 may attach to an open interlock 296 of the second robot 295. Making this attachment may triple the mass of the robot frames such that mechanical vibrations caused by moving robots are attenuated. The combination of the three robots is called a three-prong robot assembler. The middle robot workstation may be called an interstitial robot workstation 295, since it is between two other workstations. The first robot workstation 290 is adjacent to the interstitial robot workstation 295. The interstitial robot workstation 295 is adjacent to the third robot workstation 299. The first robot workstation 290 may be rigidly engaged or otherwise interlocked with the third robot workstation 299 provided that the robot workstations are attached to one or more intermediary pieces of equipment that are predominantly rigid.

Removal of a second robot or interstitial robot workstation 295 from a three-prong robot assembler 280 may include the following steps. The second robot 295 may have a left interlock 297 attached to the first robot work-support frame 290 and a right interlock 296 attached to a third robot work-support frame. Each of these interlocks may be disengaged. Any coupling of a power cable to a power source may be removed. Similarly any coupling of a data cable to a data network cable may be removed. Having removed mechanical, power and data connections, an operator may slide the interstitial robot workstation 295 from between the first robot 290 and the third robot 299.

If a minor repair or other service is required to the second robot, a removal of the robot workstation in this manner may be unnecessary. However, if a serious malfunction may require a lengthier fix, then such a removal may be necessary.

If a pallet conveyor system is supported independently of the robot workstation, then removal of the robot workstation may not affect the transfer of pallets across the pallet conveyor system from the first robot 290 to the third robot 299. On the other hand, if the pallet conveyor system is supported by the second robot, any pallets arriving from an upstream robot, e.g. the first robot 290, would have to be held in that upstream robot's cell until a pallet conveyor system could be placed in the gap left by the second robot 295. An advantage to adopting a standard width 251 for a work-support frame is that a simple work-support frame having a pallet conveyor system of the same width may be installed in any gaps left by robots requiring service. Similarly, another ‘floating’ robot according to an embodiment having an identical end effector may be placed in the gap. The floating robot placed in this space may have a left interlock attach to the first robot frame and a right interlock attach to the third robot frame, thus restoring the collective mass of the frames and attendant vibration dampening effect.

FIG. 2c shows a top view of a robot workstation according to an embodiment. The robot workstation may have two pallet conveyor systems that move through the work envelope: a primary pallet conveyor system 266 and a backup pallet conveyor system 267. A return pallet conveyor system may operate below the primary pallet conveyor system 266 or the backup pallet conveyor system 267. The return pallet conveyor system 268 may operate to return empty pallets upstream to replenish any depleted pallets. The robot has a width 251, which may be a shoulder width of a human being. The width 251 may be the distance between the leftmost extremity of the frame to the rightmost extremity of the frame, not including any interlock. FIG. 2a shows a base width 252 may be a distance between a first support leg 258 and a second support leg 259. The base width may be the distance between the broadest points of support in the longitudinal direction of the assembly line. The work envelope may be partially enclosed by a shielding material, which may be rigid, such as e.g. acrylic. A front 253, a back 255 and a top side of a robot work envelope may be protected, e.g. by flat shields, from collisions with tools or other items held by a person nearby. Such shields may include a front shield 254 and a back shield 256. It may be unnecessary to provide protection along a left frame 263 or a right frame 261 providing there is another robot workstation in those locations. It will be likely that such neighboring robot workstations would also have shields to block unwanted intrusions into their respective work envelopes. On the other hand, a robot workstation 299 that is at an end of an assembly line may have an additional shield 298 near either the left frame or the right frame planes. Shields may have openings, including those on the front 253 or the back 255 to admit parts or conduits as needed in the manufacturing process. Integrity of the robot workstations may be maintained when a interstitial robot workstation 295 is examined, serviced or removed by stopping or otherwise removing power to the robot-under-repair and at least a neighboring robot. This procedure may enhance the prevention of unwanted striking of a robot with any foreign objects not a part to be assembled into a workpiece. By establishing an economy of shielding of a robot workstation, weight may be further reduced per workstation, while reducing the overall cost to construct a robot workstation.

FIG. 2b shows an elevation view of a robot workstation according to an embodiment. A component part bin 211 is shown near the robot. A feeder 201 may automatically place parts from a bin 211 by means known in the art, including e.g. part carriers such as trays. For more precise locating of a component part within a cell envelope 213, a component part support may support one or more parts in a tray or other carrier. Alternatively, the component part support 215 may support each component part. The component part support 215 may be a horizontal surface attached to and part of the work-support frame.

A presence detector 180 may be located in the cell near where one or more parts may be placed prior to any operation performed by the end effector. Such a presence detector may provide signals to the controller 131 so that the controller may move the end effector to perform a process on such parts, e.g. picking one or more parts. If a signal from the presence detector 180 is outside a range of tolerance, or otherwise fails to meet a criteria, the controller 131 may wait select an instruction set that transmits a fault condition via the transmitter 155.

The presence detector 180 may be constructed in a variety of ways to achieve essentially the same purpose: detect three-dimensional position of one or more parts; detect orientation of one or more parts, detect completeness of one or more parts, or any combination of the foregoing. Thus the presence detector 180 may detect different levels of presence, absence, jamming, defects among other problems with the presentment of a part to the robot workstation. A presence detector 180 may create a fault signal.

Alternatively, it may be helpful in the manufacturing environment to collect other data concerning a fault. In which case, controller 131 may provide a signal based on the signal of the presence detector 180 to provide other details of a fault in a more detailed fault signal.

Many presence detectors 180 are known in the art. These may include proximity switches and more elaborate vision systems including digitizing photographic apparatus. Among others, it is known to use photo-sensors as well to identify the presence of an object. It is appreciated that the range of equivalents for a presence detector covers a vast range of sensors.

A center of gravity 271 may be located above the component part support 215. This center of gravity may take into account the combined mass of legs 115, work-support frame 111, back support 105, front support 107, track 103, slide arm 101, end effector 109, any cabling affixed to the frame 141 and 145, a controller 131, if rigidly attached to any robot frame, and any motors to the extent such motors are rigidly attached to any robot arm; and any shields attached to the frame. The center of gravity may be measured when a robot slide arm 101 and any other moving parts are at a midpoint in any range of operation. The center of gravity 271 may not include neighboring robots and neighboring frames to which the robot workstation may be rigidly attached. The center of gravity 271 may be relatively high as compared to a width. The center of gravity 271 may be high as related to a base width 252, which may extend as far side to side as any part of a leg or table that contacts a floor or other supporting surface. Such a center of gravity 271 height is determined in relation to an up-right position of the robot. Width may be the distance between sides of a frame or the left boundary 263 and the right boundary 261. Keeping the width of the robot workstation to a minimum enhances the ability to move and align a robot workstation, thus promoting an agile assembly line. A narrower width may contribute to a machine that is more easily grasped and maneuvered by a human operator. A narrower width may contribute to a lower weight of a robot workstation. In contrast, the reduction in width has in the past caused hazards in terms of tipping machinery over or otherwise rocking of a robot workstation caused by vigorous movements of the robot. Ordinarily, robot workstation width of the prior art has been kept at least as broad as the height of the center of gravity in situations where the robot workstation is not bolted to the floor. This has been done so as to assure that the robot workstation frame does not travel across the floor when high speed robot movements occur. This configuration has functioned well for robot configurations that were not bolted to the floor.

The three-prong robot assembler may be used to illustrate arrangements of robot workstations according to embodiments of the invention. Pairs of robots having at least one identical end-effector may be called redundant pairs. A robot may be a redundant pair to another robot to the extent that the controllers for each respective robot carry or otherwise store and executes a program that instructs each robot to perform a substantially identical process. Such robots may perform the same process or operation of e.g. placing a part on different chassis that move by the pallet conveyor system, or e.g. dispensing a fluid. In many cases, the robots in a redundant pair may divide the work such that of all chassis arriving at the first of the two redundant robots, roughly half are worked on by one robot, while the remainder are worked on by the second robot. Work may be shifted according to the statistical quality of each robot, for example assigning more placement operations to a robot that produces the least defects. At the most extreme level, a failed or failing robot may be assigned 0 percent of the aggregate work passing through the robot pair, thus shifting the entire load to the remaining robot. Many levels of redundancy are possible including three or more robots that perform the same work. Selecting the number of redundant robots to place in an assembly line may be based on a number of factors including availability of idle robots, and attempts to remove bottlenecks in an assembly line by sharing work among more machines.

An active robot workstation in a robot pair having at least one inactive robot workstation may be commanded to operate at a slightly higher speed than normal so that it may process more chassis and reduce a bottleneck, if any. An increase in operating speed of the active robot workstation may not produce sufficient vibration to impact part placement if the active robot workstation remains rigidly attached to one or more robot workstations.

A configuration for a pair of robot workstations that are a redundant pair may include placing each robot in neighboring positions such that one robot workstation is rigidly attached to the second robot workstation in the redundant pair. A second configuration includes intermingled other machinery, including robots between the robots in a redundant pair. FIG. 2a shows an example of such a configuration. First redundant robot 290 is located at an end of a set of three robots arranged as a three-prong robot assembler 280. The first redundant robot 290 may have a lens placement end effector, or other end-effector unique to an assembly task. Such a lens placement end effector may be used to place protective lenses on a mobile phone chassis. A second robot 295 may be rigidly attached to the first robot 290, wherein the second robot may have a different end-effector. A third robot 299 may be rigidly attached to the second robot. The third robot 299 may have the same type of end effector as the first robot, e.g. an end-effector for placing lenses.

The first robot 290 may have a substantially same programming as third robot 299 so that each may perform largely identical processes on chassis transported by one or more pallet conveyor systems. First robot 290 may have a unique address that is distinct from third robot 299, and each robot may have stored a list of addresses of robots fitting redundant criteria. Two robots may be said to be redundant if each robot: uses the same type of end effector; has substantially the same programming instructions for controlling the process at that robot workstation; is fitted to receive substantially the same part, in those cases where the process includes assembling the part into the chassis; and is positioned along the same pallet conveyor system.

Although the invention has been described in the context of particular embodiments, various alternative embodiments are possible. Thus, while the invention has been particularly shown and described with respect to specific embodiments thereof, it will be understood by those skilled in the art that changes in form and configuration may be made therein without departing from the scope and spirit of the invention.

What is claimed is:

1. A dual robot station for use in a assembly line comprising:
a first robot comprising:
a first robot arm attached to a first end effector and supported by a first frame having a range of operation between a first left frame and a first right frame, wherein the first left frame and the first right frame are separated by a width;
a first at least one pallet conveyor delivering pallets to a first exit near the first left frame from a first entrance near the first right frame;
a second robot comprising:
a second robot arm attached to a second end effector and supported by a second frame having a second range of operation between a second left frame and a second right frame, wherein the second left frame and the second right frame are separated by the width;
a second at least one pallet conveyor delivering pallets to a second exit near the second left frame from a second entrance near the second right frame;
wherein said second end effector is substantially the same as the first end effector; and
a second at least one pallet conveyor system substantially aligned with the first at least one pallet conveyor system.

2. The dual robot station of claim 1 wherein the first at least one pallet conveyor further comprises a first primary pallet conveyor system and a first backup pallet conveyor system and the second at least one pallet conveyor system comprises a second primary pallet conveyor system and a second backup pallet conveyor system.

3. The dual robot station of claim 2 wherein the first entrance is a whole multiple width from the second entrance.

4. The dual robot station of claim 1 wherein the first robot has a high center of gravity in relation to a first base width of the first robot and the second robot has a high center of gravity in relation to a second base width of the second robot.

5. The dual robot station of claim 4 wherein the first frame comprises a first interlock and the second frame comprises a second interlock, wherein the first frame is rigidly engaged to the second frame.

6. The dual robot station of claim 5 wherein the first frame is rigidly engaged adjacent to the second frame.

7. The dual robot station of claim 5 wherein the first frame is rigidly engaged to an interstitial robot workstation.

8. A dual robot station for use in a assembly line comprising:
a first robot comprising:
a first at least one arm movable between a first right boundary and a first left boundary and
a first pallet entrance;
a first pallet exit a width distance from the first pallet entrance; and
a first at least one end effector;
a second robot comprising:
a second at least one arm movable between a second left boundary and a second right boundary, the second left boundary within a short distance of the first right boundary;
a second pallet entrance;
a second pallet exit the width distance from the second pallet entrance, wherein the second pallet entrance and second pallet exit are substantially aligned with the first pallet exit; and
a second at least one end effector, wherein said second at least one end effector is substantially the same as the first at least one end effector.

9. The dual robot station of claim 8 wherein the first exit is near the second entrance.

10. The dual robot station of claim 9 wherein the first robot further comprises a work-support frame supporting the assembly line, said first work-support frame comprising a first interlock and the second robot further comprises a work-support frame supporting the assembly line, said second work-support frame comprising a second interlock.

11. The dual robot station of claim 10 wherein the first interlock is fastened to the second interlock.

12. The dual robot station of claim 10 wherein the assembly line is fastened to the first work-support frame and the assembly line is fastened to the second work-support frame.

13. The dual robot station of claim 12 wherein the first work-support frame further comprises a feeder support.

14. The dual robot station of claim 13 wherein the second work-support frame further comprises a second feeder support.

15. The dual robot station of claim 8 wherein the first right boundary and the first left boundary are substantially parallel.

16. The dual robot station of claim 15 wherein the second left boundary is substantially parallel to the first right boundary.

17. The dual robot station of claim 8 wherein the first robot further comprises a linear motor induction system having at least two degrees of freedom, wherein the first at least one end effector is supported by a first linear motor induction system and the second robot further comprises a second motor induction system having at least two degrees of freedom wherein the second at least one end effector is supported by the second linear motor induction system.

18. The dual robot station of claim 17 wherein the first at least one end effector comprises at least four end effectors.

19. The dual robot station of claim 18 wherein the second at least one end effector comprises at least four end effectors.

20. The dual robot station of claim 8 wherein the first pallet exit is a whole multiple width distance from the second pallet entrance.

21. A multi-axis robot station comprising:
a robot having at least one mating system and a cell;
a sensor for detecting a presence of a first part, said sensor having a presence output;
a transmitter for transmitting a signal based on the presence of the first part, said transmitter coupled to the presence output; and
a receiver for receiving a signal based on a presence of a remote part.

22. The multi-axis robot station of claim 21 wherein the sensor is a sensor for detecting presence of a first part in the cell.

23. The multi-axis robot station of claim 21 wherein the robot rests on a floor, further comprising:
a support base supporting said robot, said support base having a base width.

24. The multi-axis robot station of claim 23 further comprising a pallet conveyor system extending substantially the base width of the multi-axis robot station.

25. The multi-axis robot station of claim 23 wherein said at least one mating system comprises at least two mating systems and each of said at least two mating systems has an end effector rigidly engaged thereto.

26. The multi-axis robot station of claim 23 further comprising:
at least one motive means for moving the robot; and
a controller having a unique address whereby said controller controls at least one motive means.

27. The multi-axis robot station of claim 22 wherein the transmitter transmits the presence signal according to a high speed wired data protocol.

28. The multi-axis robot station of claim 22 wherein the transmitter transmits the presence signal according to a high speed wireless data protocol.

29. The multi-axis robot station of claim 23 further comprising:
a feeder supported by the support base.

30. The multi-axis robot station of claim 21 wherein said at least one mating system comprises at least two mating systems and each of said at least two mating systems has an end effector rigidly engaged thereto.

31. The multi-axis robot station of claim 23 wherein the support base supports at least one shield.

32. The multi-axis robot station of claim 23 wherein the support base together with the robot, has a center of gravity at least a base width above the floor.

33. The multi-axis robot station of claim 21 wherein the mating system has at least one electric output.

34. The multi-axis robot station of claim 21 wherein the mating system has at least one electric input.

35. The multi-axis robot station of claim 21 wherein the mating system has at least one fluid bulkhead.

36. The mulbi-axis robot station of claim 21 wherein the at least one electric input carries a presence signal.

37. The multi-axis robot station of claim 21 wherein the transmitter transmits the presence signal according to a high speed wired data protocol.

38. The multi-axis robot station of claim 21 wherein the transmitter transmits the presence signal according to IEEE 1394 protocol.

39. The multi-axis robot station of claim 21 wherein the transmitter transmits the presence signal according to a high speed wireless data protocol.

40. The multi-axis robot station of claim 21 wherein the transmitter transmits the presence signal according to bluetooth protocol.

41. The multi-axis robot station of claim 21 wherein the presence signal is based on a signal from a tactile feedback sensor.

42. The multi-axis robot station of claim 21 further comprising:
at least one motive means for moving the robot; and
a controller having a unique address whereby said controller controls at least one motive means.

43. The multi-axis robot station of claim 21 further comprising:
at least one interlock.

44. The multi-axis robot station of claim 43 wherein the at least one interlock is oriented horizontally.

45. The multi-axis robot station of claim 43 wherein the mating system has at least one electric output.

46. The multi-axis robot station of claim 43 wherein the mating system has at least one electric input.

48. The multi-axis robot station of claim 43 wherein the mating system has at least one fluid bulkhead.

49. The multi-axis robot station of claim 43 wherein the at least one electric input carries a presence signal.

50. The multi-axis robot station of claim 43 wherein the transmitter transmits the presence signal according to a high speed wired data protocol.

51. The multi-axis robot station of claim 43 wherein the transmitter transmits the presence signal according to a high speed wireless data protocol.

52. The multi-axis robot station of claim 43 wherein the transmitter transmits the presence signal according to IEEE 1394 protocol.

53. The multi-axis robot station of claim 43 wherein the transmitter transmits the presence signal according to bluetooth protocol.

54. The multi-axis robot station of claim 43 wherein the presence signal is based on a signal from a tactile feedback sensor.
